(19) United States
(12) Patent Application Publication
(10) Pub. No.: US 2004/0153278 A1
(43) Pub. Date: Aug. 5, 2004

(54) Signal flow driven circuit physical synthesis technique

(76) Inventors: Pengfei Zhang, Fremont, CA (US); Xisheng Zhang, Sunnyvale, CA (US); Yuping Wu, Beijing (CN)

Correspondence Address: Xisheng Zhang, 1336 Flicker Way, Sunnyvale, CA, 94087, US

(21) Appl. No.: 10/762,791

(22) Filed: Jan. 23, 2004

Related U.S. Application Data
(60) Provisional application No. 60/442,307, filed on Jan. 27, 2003.

(51) Int. Cl. G06F 19/00

(52) U.S. Cl. 702/117

(57) ABSTRACT

A signal flow driven circuit physical synthesis technique for automatic generation of a high performance and compact layout from a circuit schematic based on signal flow information. The signal flow driven layout methodology is based on two observations: matching and symmetry requirement most critical with devices in the critical signal paths, parasitic reduction (mostly capacitance, resistance, and inductance if possible) is most critical with circuit nodes in the signal path. The inventive device includes input module, critical device generator, signal flow driven placement module, and parasitic aware routing module. Input module loads circuit netlist, technology files, signal flow information and parasitic constraints. Critical device generator synthesizes circuit component with optimized for matching, symmetry, area and parasitic loading. Placement module places circuit components while optimizing for those in the critical signal flow. Routing module achieves routing for all nets while observing parasitic loading constraints.

### CROSS-REFERENCE TO RELATED APPLICATIONS

This application claims priority to and the benefit of the filing date of provisional patent application Serial No. 60/442,307 filed Jan. 27, 2003.

### BACKGROUND OF THE INVENTION

1. Field of the Invention

The present invention relates generally to analog layout generation and more specifically it relates to a signal flow driven circuit physical synthesis technique for automatic generation of a high performance and compact layout from a circuit schematic based on signal flow information. The signal flow driven layout methodology is based on two observations: matching and symmetry requirement most critical with devices in the critical signal paths, parasitic reduction (mostly capacitance, resistance, and inductance if possible) is most critical with circuit nodes in the signal path.

2. Description of the Related Art

It can be appreciated that analog layout generation have been in use for years. Typically, analog layout generation are comprised of mostly manual generation of layout, researches in analog/RF layout automation are mostly constraint-driven.

The main problem with conventional analog layout generation are manual layout is time consuming, error prone and extremely low in productivity. Another problem with conventional analog layout generation are conventional constraint-driven layout automation has not become practical as it is very difficult to generate a set of reasonable constraints. Another problem with conventional analog layout generation are that evaluation of placement or routing solution against certain set of constraints often prohibitively time consuming and computational power hungry.

While these devices may be suitable for the particular purpose to which they address, they are not as suitable for automatic generation of a high performance and compact layout from a circuit schematic based on signal flow information. The signal flow driven layout methodology is based on two observations: matching and symmetry requirement most critical with devices in the critical signal paths, parasitic reduction (mostly capacitance, resistance, and inductance if possible) is most critical with circuit nodes in the signal path. The main problem with conventional analog layout generation are manual layout is time consuming, error prone and extremely low in productivity. Another problem is conventional constraint-driven layout automation has not become practical as it is very difficult to generate a set of reasonable constraints. Also, another problem is that evaluation of placement or routing solution against certain set of constraints often prohibitively time consuming and computational power hungry.

In these respects, the signal flow driven circuit physical synthesis technique according to the present invention substantially departs from the conventional concepts and designs of the prior art, and in so doing provides an apparatus primarily developed for the purpose of automatic generation of a high performance and compact layout from a circuit schematic based on signal flow information. The signal flow driven layout methodology is based on two observations: matching and symmetry requirement most critical with devices in the critical signal paths, parasitic reduction (mostly capacitance, resistance, and inductance if possible) is most critical with circuit nodes in the signal path.

### SUMMARY OF THE INVENTION

In view of the foregoing disadvantages inherent in the known types of analog layout generation now present in the prior art, the present invention provides a new signal flow driven circuit physical synthesis technique construction wherein the same can be utilized for automatic generation of a high performance and compact layout from a circuit schematic based on signal flow information. The signal flow driven layout methodology is based on two observations: matching and symmetry requirement most critical with devices in the critical signal paths, parasitic reduction (mostly capacitance, resistance, and inductance if possible) is most critical with circuit nodes in the signal path.

The general purpose of the present invention, which will be described subsequently in greater detail, is to provide a new signal flow driven circuit physical synthesis technique that has many of the advantages of the analog layout generation mentioned heretofore and many novel features that result in a new signal flow driven circuit physical synthesis technique which is not anticipated, rendered obvious, suggested, or even implied by any of the prior art analog layout generation, either alone or in any combination thereof.

To attain this, the present invention generally comprises input module; critical device generator; signal flow driven placement module and parasitic aware routing module. Input module loads circuit netlist, technology files, signal flow information and parasitic constraints. Critical device generator synthesizes circuit component with optimized for matching, symmetry, area and parasitic loading. Placement module places circuit components while optimizing for those in the critical signal flow. Routing module achieves routing for all nets while observing parasitic loading constraints.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a signal flow driven circuit physical synthesis technique that will overcome the shortcomings of the prior art devices.

Another object is to provide a signal flow driven circuit physical synthesis technique that generates layout constrains based on signal flow information that is more realistic and practical.

Another object is to provide a signal flow driven circuit physical synthesis technique that will be a complete system/methodology of placement based on signal flow that allows signal path cells to be placed with high priority.

Another object is to provide a signal flow driven circuit physical synthesis technique that will be a complete system/methodology of routing based on signal flow that allows critical path to be routed with high priority.

An object of the present invention is to provide a signal flow driven circuit physical synthesis technique for automatic generation of a high performance and compact layout from a circuit schematic based on signal flow information. The signal flow driven layout methodology is based on two observations: matching and symmetry requirement most critical with devices in the critical signal paths, parasitic reduction (mostly capacitance, resistance, and inductance if possible) is most critical with circuit nodes in the signal path.

Another object is to provide a signal flow driven circuit physical synthesis technique that automatically synthesizes a physical layout from an existing analog/RF circuit netlist based on critical signal flow path.

Another object is to provide a signal flow driven circuit physical synthesis technique that generate analog/RF circuit component layout unit based on performance and physical requirement automatically.

Another object is to provide a signal flow driven circuit physical synthesis technique that achieves analog/RF circuit layout automation with guaranteed circuit performance.

Another object is to provide a signal flow driven circuit physical synthesis technique that synthesizes the physical layout of analog/RF circuit while observing the critical signal flows, matching and symmetry requirement and parasitic loading constraints.

Another object is to provide a signal flow driven circuit physical synthesis technique that automatically does circuit cell physical placement and route allowing efficient layout floor planning for analogy/RF circuit automation.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 Signal Flow Driven Analog/RF Circuit Physical Synthesis Technique Flow Chart.

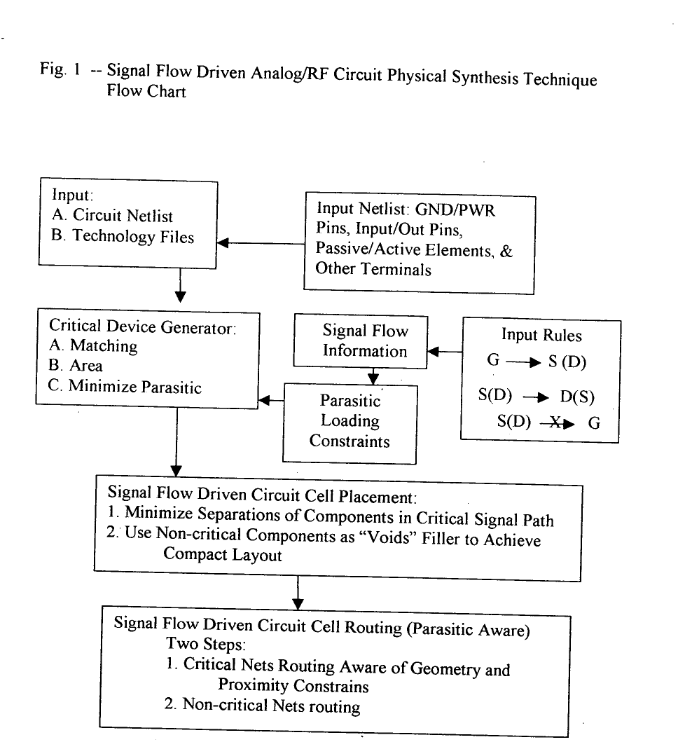

FIG. 2 Mean of Circuit Performance Assurance, Mean of Physical Layout Floor Planning, and Mean of Incorporating an In-situ Parasitic Extraction Process Flow Chart

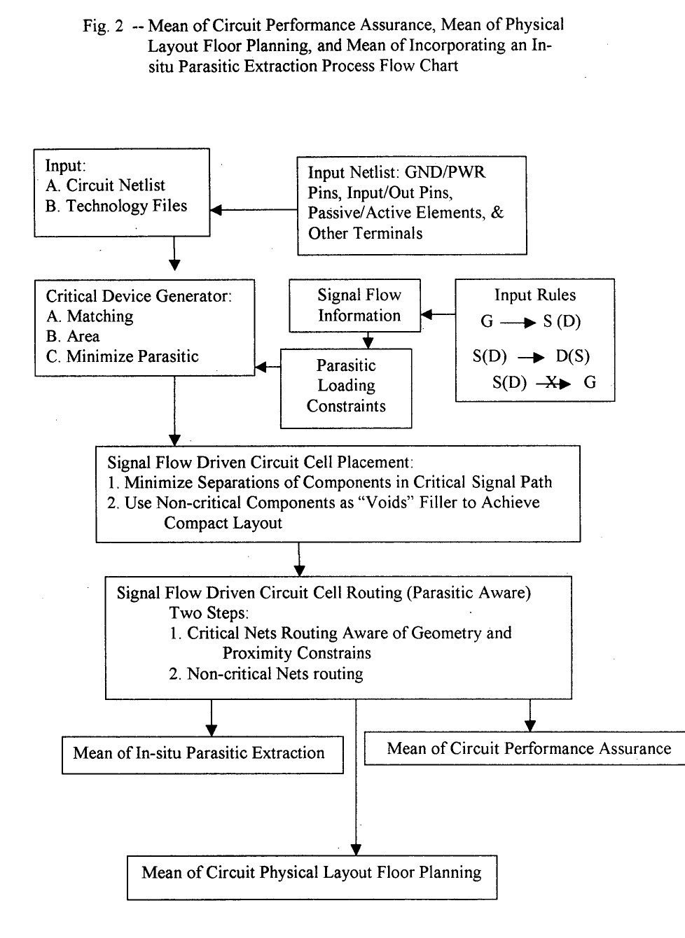

### DETAILED DESCRIPTION OF THEE INVENTION

Turning now descriptively to the drawings, in which similar reference characters denote similar elements throughout the several views. The attached figures illustrate a signal flow driven circuit physical synthesis technique, which comprises input module; critical device generator; signal flow driven placement module, and parasitic aware routing module. Input module loads circuit netlist, technology files, signal flow information and parasitic constraints. Critical device generator synthesizes circuit component with optimized for matching, symmetry, area and parasitic loading. Placement module places circuit components while optimizing for those in the critical signal flow. Routing module achieves routing for all nets while observing parasitic loading constraints.

Input module loads circuit netlist, technology files, signal flow information and parasitic constraints. Input module parses the circuit netlist and loads the technology files that necessary for the layout generation. More importantly, it reads in the signal flow information and physical requirement of circuit components and interconnects. Input module can be a graphical user interface that receives user manual input. Input module can be a background reader that takes textual file as input. Input module can be a combination of both user manual input and background data processing tool. Input module can also be a circuit analysis module that automatic generates signal flow information and parasitic constraints.

Critical device generator synthesizes circuit component with optimized for matching, symmetry, area and parasitic loading. Critical device generator synthesizes the physical layout at the unit circuit level while observing matching and loading requirement. Critical device generator can be an integrated part of the physical synthesis tool. Critical device generator can also be a stand-alone tool that employed separately in any analog/RF circuit design flow. Critical device generator can perform on itself with built-in rules. Critical device generator can be driven by requirement generated by automatic circuit analyzer and/or user manual input.

Placement module places circuit components while optimizing for those in the critical signal flow. The placement module automatically obtains an optimized placement by minimizing the separation of circuit components in the critical signal path to guarantee the performance and by filling in the “voids” with non-critical components to achieve compact layout area. Signal flow driven placement methodology can be employed at circuit component level. Signal flow driven placement methodology can be employed at block level.

Routing module achieves routing for all nets while observing parasitic loading constraints. Routing module achieves successful routing in 2 steps: it routs first the critical signal flow observing geometry and proximity constraints and then routs all other nets. Routing module can be a grid-based router. Routing module can be grid-less router. Routing module can also incorporate in-situ parasitic extraction.

The suggested process flow is as follows: input module first loads all input information and other required files, device generator comes into process flow to build all necessary circuit components, next the placement module comes into play and generates the optimized layout placement, finally the routing module completes the physical synthesis by connecting all the nets. Each module can be used separately in other physical design flow. Each module or more than one of these modules can be used in various manners in other design flow.

Input information loader reads in the netlist file, layout constraints, and the technology files. The netlist file can be in CDL netlist format or spice netlist file. The layout includes the place-net constraints and the routing constraints. The technology file can make the layout synthesis tool support different technology. Integrated device generator generates the device layout cell for each device or device combination according to the requirements based on the input netlist. It has the specific considerations for each kind of devices. It will produce the device layout with the best device performance, and reduce the designer's manual work.

Another device layout source is from the Ecell manager, which provides the interface to access the intellectual property layout cell that makes the layout reuse become possible and speed up the layout synthesis. Because the layout synthesis for the functional block is time consuming so that, the direct use of the layout that was verified before becomes critical. It is also useful to joint-design in a large design group. After the layout cells were prepared, the critical signal path-oriented layout optimizer does place and route all the cells on the critical signal paths according to the signal flow directions. After the critical signal path was layout, the not critical portion oriented void-filler does place and route all the not critical portion just like void filling to reduce minimize the chip area. Automatic circuit cell physical placement and route also allow efficient layout floor planning for analogy/RF circuit automation.

In each layout synthesis attempt, the integrated in-situ parasitic extractor is used to evaluate the parasitic effects. The integrated in-situ parasitic extractor works like a general parasitic extractor, the extracted object is not the whole layout, but the specified nets, the extraction accuracy is also controlled by the parasitic constraints which is generated at the stage of circuit analysis; because the extraction accuracy is changed adaptively and the scope of the extracted layout is specified, the parasitic extraction is speeded up.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A signal flow driven circuit analysis technique by tracing circuit signal flow so that, analyzing a circuit, and partitioning a circuit based on functionality and criticality, and generating multitude circuit layout constraints are done by software program automatically.

2. A signal flow driven circuit physical synthesis technique by tracing circuit signal flow so that, placing and routing circuit cell physical layout based on giving critical signal path with high priority are done by software program automatically.

3. A signal flow driven circuit physical synthesis technique of claim 2 comprising:
(a) Providing a memory that is able to store a circuit netlist employing input and output pins, any other terminal pins, power and ground terminals, active device elements, and passive device elements; and
(b) Storing said circuit netlist in said memories; and
(c) Providing a memory that is able to store a series of technology files in said memory; and
(d) Storing said series of technology files in said memory; and
(e) Providing a memory that is able to store a series of signal flow information generated from the signal flow driven circuit analysis technique of claim 1 in said memory; and
(f) Storing said series of signal flow information in said memory; and
(g) Providing a memory that is able to store said multitude circuit layout constraints generated from the signal flow driven circuit analysis technique of claim 1 and from said signal flow information in said memory, and a series of parasitic loading constraints generated from said signal flow information, and a series of geometry constraint generated from said signal flow information, and a series of proximity constraints generated from said signal flow information in said memory; and
(h) Storing said multitude circuit layout constraints, and said series of parasitic loading constraints, and said series of geometry constraint, and said series of proximity constraints in said memory; and
(i) Providing a memory that is able to store a critical device generator in said memory; and
(j) Storing said critical device generator in said memory; and
(k) Utilizing said circuit netlist, and said series of technology files, and said signal flow information, and said multitude layout constraints, and said parasitic loading constraints, and said critical device generator to synthesize a series of circuit component layouts and a series of unit circuit layouts while observing optimized matching, optimized area, optimized symmetry, and optimized parasitic loading requirements.

4. The signal flow driven circuit physical synthesis technique of claim 2 further including a signal flow driven circuit cell placement methodology comprising:
(a) Providing a memory that is able to store a placement module in said memory; and
(b) Storing said placement module in said memory; and
(c) Providing a memory that is able to store a series of matching requirements of a series of devices associated with a critical signal flow path and a series of symmetry requirements of said series of devices associated with said critical signal flow path in said memory; and
(d) Utilizing said placement module and the signal flow driven circuit physical synthesis technique of claim 3 wherein said series of circuit component layouts and wherein said series of unit circuit layouts to layout said circuit providing minimized separations of the circuit component layouts and the unit circuit layouts in said critical signal flow path; and
(e) Utilizing said placement module to place a series of non-critical components in rest of said area; and
Whereby an engineer can achieve compact layout for an analog circuit, a mixed signal circuit, and a RF circuit automatically.

5. The signal flow driven circuit physical synthesis technique of claim 2 further including a signal flow driven circuit cell routing methodology comprising:
(a) Proving a memory that is able to store a routing module in said memory; and
(b) Storing said routing module in said memory; and
(c) Providing a memory that is able to store a series of parasitic loading constraints of multitude circuit nodes of a critical signal flow path in said memory; and
(d) Utilizing said routing module, and said series of parasitic loading constraints, and the signal flow driven circuit physical synthesis technique of claim 3 wherein said geometry constraints and said proximity constraints to connect a series of critical nets in said critical signal flow path of said circuit before connecting a series of non-critical nets in said circuit; and
Whereby an engineer can route an analog circuit, a mixed signal circuit, and a RF circuit automatically.

6. A mean of circuit performance assurance utilizing:
(a) The signal flow driven circuit analysis technique of claim 1; and
(b) The signal flow driven circuit physical synthesis technique of claim 2; and
(c) The signal flow driven circuit cell placement methodology of claim 4; and,
(d) The signal flow driven circuit cell routing methodology of claim 5.

7. A mean for circuit physical layout floor planning utilizing:
(a) The signal flow driven circuit analysis technique of claim 1; and
(b) The signal flow driven circuit physical synthesis technique of claim 2; and
(c) The signal flow driven circuit cell placement methodology of claim 4; and
(d) The signal flow driven circuit cell routing methodology of claim 5.

8. A mean of incorporating an in-situ parasitic extraction process having the signal flow driven circuit cell routing methodology of claim 5 wherein said routing module incorporated in said in-situ parasitic extraction process.
